(19) United States
(12) Patent Application Publication
(10) Pub. No.: US 2002/0111768 A1
(43) Pub. Date: Aug. 15, 2002

(54) Infrared timing meter system

(76) Inventors: Sleiman R. Ghorayeb, East Meadow, NY (US); Joseph L. DiBiasi, Brooklyn, NY (US)

Correspondence Address: Neil M. Zipkin, Esq., Amster, Rothstein & Ebenstein, 90 Park Avenue, New York, NY, 10016, US

(21) Appl. No.: 09/726,936

(22) Filed: Nov. 30, 2000

(51) Int. Cl. G04F 1/00; G04F 3/00; G04F 5/00; G04G 5/00; G04G 7/00; G04F 7/00; G04F 8/00; G04F 10/00; G06F 15/00; G04G 15/00

(52) U.S. Cl. 702/178

(57) ABSTRACT

An electronic timing meter device that can receive an infrared (“IR”) communication signal from a remote control device operated, for example, by a vehicle owner. This IR remote device transmits information about the user and contains an identification code that is specific to that user. The identification code and possibly other user information is received by the timing meter device and stored in the computer memory of the timing meter device. Upon receipt of the code and other information from the user, the electronic timing meter device starts the counter to record the length of time the user is parked. The length of time the user is parked is determined by the receipt of another signal from the user to stop the meter's counting, upon the passage of a predetermined maximum amount of time, upon receipt of a signal received from a new user's device once the old user leaves the parking location or in response to a signal from the motion or proximity detector that the user's vehicle has left the parking location monitored by the timing meter device. The recorded information is then used to deduct money from each user's account, thus avoiding the need to deposit and collect physical change, as in mechanical parking meters.

### BACKGROUND OF THE INVENTION

The present invention relates generally to the field of electronic timing devices and, in particular, to electronic parking meters that operate using infrared signals.

Mechanical parking meters are well known in the prior art and are typically of the type where the allowable time is determined by the number and denomination of coins which are placed in the parking meter. A clock mechanism in the parking meter runs down the allowable time until it reaches zero, and an overtime parking indication appears on the meter display. The use of traditional parking meters thus requires that some change, usually quarters, be inserted into the meter in order to purchase parking time. Coin receiving mechanisms which use infrared (“IR”) detectors, Hall-effect circuitry, magnetic fields and light sensing rays with microprocessors include U.S. Pat. No. 4,483,431 (Pratt); U.S. Pat. No. 4,460,080 (Howard); U.S. Pat. No. 4,249,648 (Meyer) and U.S. Pat. No. 5,119,916 (Carmen et al.). These coin receiving mechanisms perform various tests to determine the denomination of the coin and test whether an acceptable coin has been inserted. However, the user of a parking meter still has to physically carry and deposit the correct amount into the meter, and the user is limited by the maximum amount of time that can be paid for at a time. Thus, if the user of a particular parking meter is late in depositing additional change, or miscalculates the amount of required time, he or she risks receiving a parking ticket from the parking monitor or police. One object of the present invention is to provide an electronic parking meter that uses infrared communication to debit or deduct money from the account of parking meter's user, avoiding the burden and necessity of carrying and physically depositing change into the meter and providing the ability to purchase a flexible amount of parking time.

Additionally, in the parking systems that require physical deposit of coins or bills into the meter, the deposited money is stored in the meter and then must be collected at various time intervals by the parking monitors, police or collection authorities. These meters are often subjected to abuse, theft of stored money, entry of false coins and other treatment rendering them inoperative. Thus, there is a need for a parking meter system that would avoid the requirement to physically store money inside the meter. Accordingly, another object of the present invention is to provide an electronic parking meter that uses infrared communication to provide a secure means to debit or deduct money from the account of a parking meter's user, avoiding any need to store money inside the meter and reducing the potential for the theft and abuse of parking meters.

In the parking systems known in the art, parking monitors, police or traffic authorities must examine each parking meter display to determine if the time purchased by the user of that meter has expired, and issue a parking ticket accordingly. This examination of each parking meter usually necessitates an up-close inspection of the display of each parking meter, which is very time consuming and inefficient. Thus, there is a great need for a parking meter system that allows for a quick and efficient inspection of multiple meter displays by parking monitors or police to determine if a particular vehicle owner has not paid the parking fee. Therefore, it is another object of the current invention to provide an electronic parking meter that has a simple and highly visible display to indicate whether proper parking fees have been paid, and also provide parking authorities with means to perform a quick and efficient collection and verification of billing records from each parking meter, utilizing an IR master remote device.

Conventional parking meters have a maximum time that a user can purchase at a time. Thus, if a user wants to park for a period that exceeds the maximum time that can be purchased at one time, the user has to return to purchase more time. If the user fails to return before the expiration of time that was previously purchased, the user risks a fine. On the other hand, if the user does not want to or can not return, he is forced to purchase more time than he may need, which results in overpayment by the user if he returns prior to expiration of the time purchased. Thus, it is desirable to allow the user greater control of the time he can purchase at a time and it is an object of this invention to allow the user to set the maximum amount of time the user may be charged in predetermined steps of time.

Other general and specific objects of the current invention will be obvious and will appear hereinafter.

### SUMMARY OF THE INVENTION

Accordingly, it is the general object of this invention to provide an electronic timing meter system, which improves upon and overcomes the disadvantages of the prior art.

The present invention provides an electronic timing meter device that can receive an infrared (“IR”) communication signal from a remote control device operated by the vehicle owner. This IR remote device both controls certain functions of the electronic timing devices and transmits information about the user including a secure identification code that is specific to that user. The secure identification code and possibly other user information is received by the timing meter device and stored in the computer memory of the timing meter device. Upon receipt of the code and other information from the user, the electronic timing meter device starts the counter to record the length of time the user is parked. The length of time the user is parked is determined either by the receipt of another signal from a user to stop the meter's counting, upon the passage of a predetermined maximum amount of time, upon receipt of a signal received from a new user's device once the old user leaves the parking location or in response to a signal from a motion or proximity detector that the user's vehicle has left the parking location monitored by the timing meter device. This resetting of the timing meter device upon departure of the user's vehicle maximizes the revenue from that meter device because any new user that parks in that location must activate it with his or her own IR remote device and will be billed starting upon his or her occupation of that parking location because the timing device will be reset eliminating any paid time remaining from the old user.

The electronic timing meter device records and stores information about the use of a parking space by each user of the parking meter for collection by authorized individuals. This information is then used to deduct money from each user's account, thus avoiding the need to deposit and collect physical change, as in mechanical parking meters. The information related to the use of each parking meter may be collected by authorized individuals from each parking meter individually utilizing a master remote device, or, in the alternative, may be sent through a computerized system to the central host system that would process billing information for each user and debit his or her account.

Yet another aspect of the current invention is to provide a timing meter system that is able to transmit stored information to the master remote device of the authorized parking authorities for collection and accounting. This information is then used to deduct money from each user's account, thus avoiding the need to deposit and collect physical change as in mechanical parking meters.

A further aspect of the current invention is the ability to store information related to the specific parking meter, preferably in the computer memory of the timing meter device. This information may include, among other things, the cost of using that timing meter per unit of time for that day, the maximum duration that each user is allowed to park at a certain location and the restrictions for parking at certain times or on certain days. Furthermore, the timing meter device of the current invention may be reprogrammed, and different information related to the prices and restrictions, for example, maximum amount of time a user can be charged for may be stored in the computer memory of the timing meter device, thereby allowing for an easy and efficient modification of the system in accordance with changes in parking regulations.

The electronic timing meter system of present invention may also be utilized for telephones, fuel pumps, copying machines, soda machines, and other similar systems, where the user of a telephone, fuel pump or other similar devices would be able to activate them with an IR remote device, which in turn would store user data and activate a counter that records the time of a phone call, the amount of fuel purchased, number of copies or amount of soda purchased by the user, who is then billed for it at a later time.

### BRIEF DESCRIPTION OF THE DRAWING

These and other objects, features and advantages of the invention, its construction and operation will be best understood from the following detailed description of preferred embodiments of the present invention, taken in conjunction with the accompanying drawing, of which:

FIG. 1 is a simplified pictorial illustration of the timing meter system according to the present invention;

FIG. 2A is a front view of the timing meter device according to the present invention;

FIG. 2B is a front view of the remote device according to the present invention;

FIG. 3 is a block diagram depicting the individual components of the timing meter device, user's infrared remote device and infrared master remote used by the parking authority according to the present invention;

FIG. 4 is a flowchart of a sequence of logical steps that are executed by the timing meter device in response to the reception of an infrared signal from the user's infrared remote device;

FIG. 5 is a circuit schematic of an embodiment of an infrared remote device utilized by the user of a timing meter device according to the present invention;

FIG. 6 is a flowchart of a sequence of logical steps that are performed by the timing meter device in response to the request for the billing data from the master remote device according to the present invention; and

FIG. 7 is a flowchart of a sequence of logical steps that are performed by the infrared remote master device when extracting the billing data from the timing meter device according to the present invention.

### DETAILED DESCRIPTION

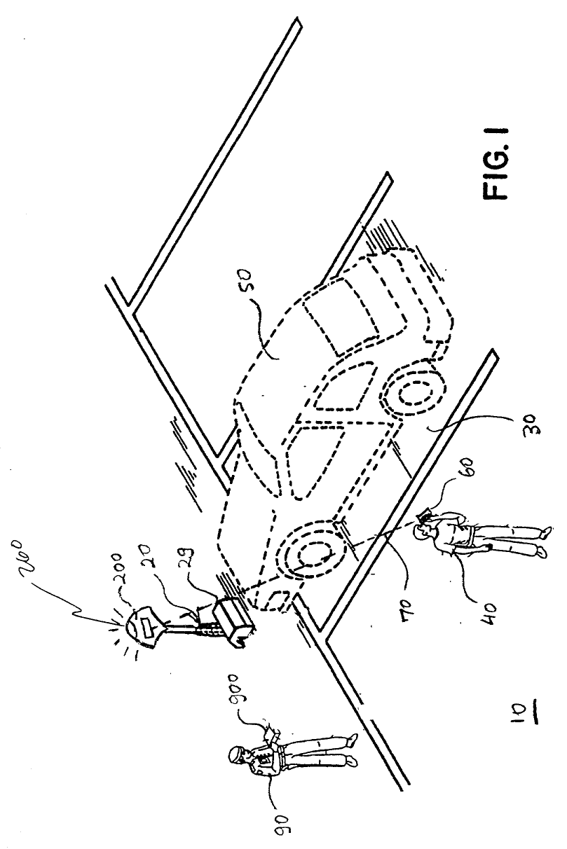

FIG. 1 illustrates a timing meter system 10 according to the present invention, particularly adapted for monitoring the length of time that a user 40 utilizes a parking location 30 corresponding to a timing meter device 20. The timing meter system 10 includes the timing meter device 20, a remote device 60 and a master remote device 900. The user 40 of the timing meter device 20 activates a counter in the timing meter device 20 by transmitting an infrared signal 70 from the remote device 60 to the timing meter device 20. As a part of the IR signal 70, the remote device 60 transmits a unique identification code, which identifies the user 40 and allows the timing meter device 20 to associate the time interval that the parking location 30 is utilized with the user 40. The timing meter device 20 stores the user's information for future collection by parking authorities 90 via use of the master remote device 900. Upon receipt of a second IR signal 70 from the same remote device 60 the timing meter device 20 stops the counter and displays the time elapsed between the two IR signals on a display device 200.

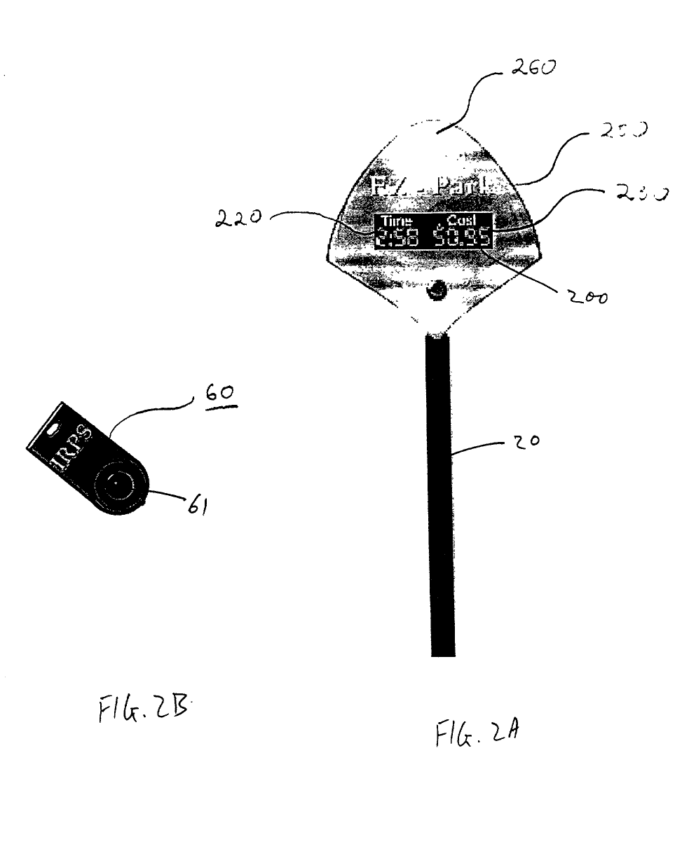

FIG. 2A Illustrates one embodiment of the timing meter device 20 having the display 200. Displayed on the display 200 is a length of elapsed time 220 that the timing meter device 20 was utilized by the user 40, and a total cost display 230 associated with that use. Alternatively, “Parked” or a similar indicia may be displayed on the display 200. The display 200 and the internal mechanisms of the timing meter device 20 are preferably covered by an outer shell 250. The outer shell 250 may provide shielding from the external sources of electromagnetic signals or fields that may interfere with reception of the IR signals by the timing meter device 20. An indicator light 260 is visible through the outer shell 250. The indicator light 260, which may be a LED, can be of different colors, for example, red, yellow and green, with each color indicating status of the parking meter.

FIG. 2B illustrates one embodiment of the remote device 60 having a button 61. When the button 61 is pressed the remote control transmits the IR signal 70 (FIG. 1). The timing meter device 20 may also include a power source 28, (not shown) for example, a rechargeable battery that can be recharged by solar radiation.

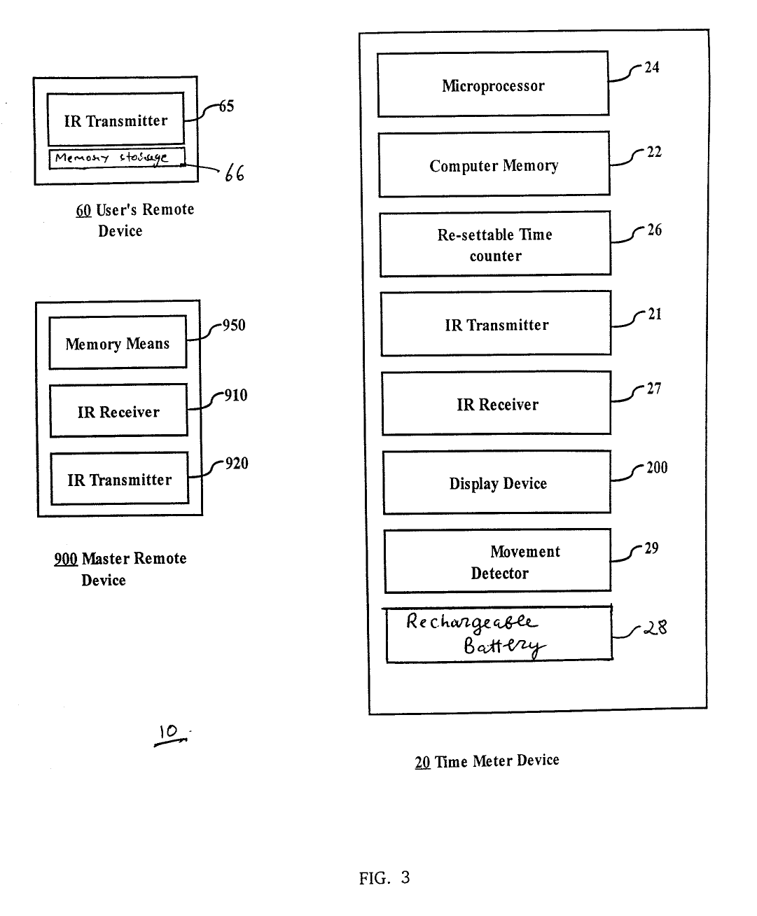

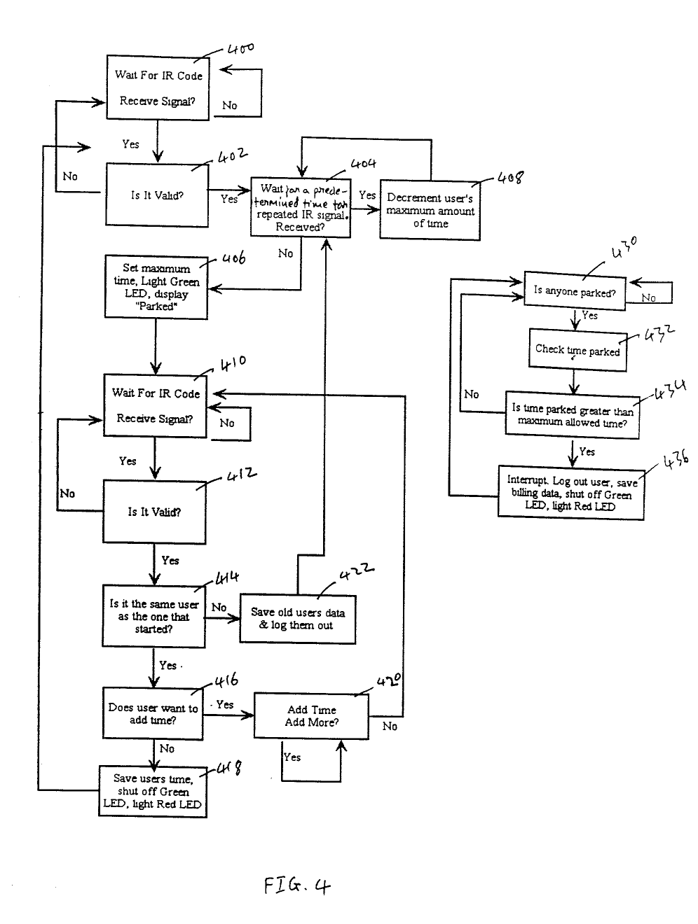

FIG. 3 illustrates, in a block diagram, further details of the timing meter system 10. The timing meter system 10, as illustrated in FIG. 3, includes the timing meter device 20, the master remote device 900 and the remote device 60, each described in detail hereinafter. The timing meter device 20 includes a microprocessor 24 that executes a sequence of computer instructions according to the general steps of an algorithm shown in FIG. 4 and described later. An example of a computer program written in interactive C language that operates the timing meter device 20 according to the steps of the algorithm is included in Appendix A.

The timing meter device also includes a storage means, e.g., a computer memory 22 (preferably a programmable random access memory) controlled by the microprocessor which is coupled to and directs the operation of a re-settable timer counter 26. The timer counter 26 may be a clock or any other device that is able to record the time interval that the parking facility is utilized by the user 40 (FIG. 1), who parks his or her vehicle 50 (FIG. 1) in the location 30 (FIG. 1) that is monitored by the timing meter device 20. The information about the usage of the timing meter device 20 is stored in the computer memory 22. Also included in the timing meter device 20 is an IR transmitter 21 and an IR receiver 27. The IR receiver 27 receives IR signal from the remote device 60 and the master remote device 900. The IR transmitter 21 transmits IR signals to the master remote device 900, the IR signals carrying data such as the usage information stored in the computer is memory. The IR transmitter 21 is coupled to the computer memory 22, and the IR receiver 27 is coupled to the microprocessor 24. The display device 200 is included in the timing meter device 20. The display device 200 is coupled to microprocessor 24, and displays previously described information as directed by the microprocessor 24. The timing meter device 20 also includes a power source 28, e.g., a rechargeable solar powered battery and optionally a motion detector 29. The motion detector 29 is coupled to the microprocessor 24.

The timing meter system 10 includes a remote device 60 having an IR transmitter 65 and a storage 66 coupled to the IR transmitter 65. The storage 66 has user specific information that is transmitted by IR transmitter 65 when button 61 (FIG. 2B) is pressed.

The timing meter system 10 also includes a master remote device 900 which has a memory means 950 coupled to an IR transmitter 920 and an IR receiver 910. The master remote device 900 transmits a signal to the timing meter device 20 that tells the timing meter device 20 that the user of the master remote device 900 is the parking authority 90 (FIG. 1). Upon receipt of such signal from the master remote device 900, the timing meter device 20 transmits the stored data to the master remote device 900 where the data is received by IR receiver 910 and stored in the memory means 950.

FIG. 4 shows, in a flow diagram, the steps of an illustrative algorithm executed in the timing meter device 20. The timing meter device 20, in step 400, awaits receipt of a signal. Upon receipt of a signal, in step 402 the microprocessor 24 (FIG. 3) decides if the signal is valid. If the signal is valid the timing meter device 20 waits for a predetermined amount of time (step 404) for a repeated signal, and if it does not receive a repeated signal during the predetermined time, it sets, in step 406, the maximum time this user can be charged, lights the LED 260 (FIG. 2A), displays “Parked” on the display 200 (FIG. 2A) and starts the re-settable time counter 26 (FIG. 3). If a repeated signal was received, in step 408, the maximum amount of time that can be charged to this user is decreased by a predetermined amount and the timing meter device 20 returned to step 404. Alternatively, the maximum amount of time that can be charged to this user may be incremented in step 408. After starting the re-settable time counter 26 the timing meter device 20 waits for a signal (step 410). Upon receipt of a signal, in step 412, the microprocessor 24 decides if it is a valid signal. If the signal is not valid the timing meter device 20 is returned to step 410. If the signal is valid, and it is from the same user as the previous signal (step 414) and the user does not want to add time (step 416), the resettable counter is stopped, the LED color is changed and time corresponding to this user's usage is stored in memory 22 (FIG. 3) (step 418). However, if the user wanted to add time to his maximum allowable time, time is added (step 420) and the timing meter device 20 returned to step 420. If the user does not want to further add more time the timing meter device 20 is returned to step 410. If at step 414 the signal received is not from the same user as the previous signal, the next step is step 422, wherein the use data for the user corresponding to the previous signal is stored, the previous user is logged out and the timing meter device 20 returned to step 404.

If the timing meter device 20 has the user 40 (FIG. 1) parked (step 430), it keeps checking (step 432) the time that has elapsed. If the elapsed time exceeds maximum allowed time (step 434), the timing meter device 20 logs out the user 40, saves the billings data and turns on the indicator light 260 (step 436) that indicates expiration of maximum allowed time. If the elapsed time is less than the maximum allowed time, the timing meter device 20 returns to step 430.

In the preferred embodiment of the timing meter device 20 the microprocessor 24 is, for example, a Motorola 68HC11 microprocessor, the computer memory 22 is, for example, on an MIT Handy board and the clock signal is provided by, for example, a 555 digital timer. The preferred embodiment of the timing meter device 20 may receive a code as the input.

The microprocessor 24 may execute a sequence of computer instructions to calculate and store in the computer memory 22 of the timing meter device 20 the actual cost associated with the use of the timing meter device 20 by each individual user 40, as well as the total revenue derived from the use of that timing meter device 20. The timing meter device 20 may also store information specific to the use of the timing meter device 20 including information, such as the maximum duration that users 40 are allowed to park at a certain location, the restrictions for parking at certain times or on certain days, special rates for senior citizens or special events.

The computer memory 22 of the timing meter device 20 may also be reprogrammed and different information related to the prices and restrictions may be stored in the computer memory 22 of the timing meter device 20, thereby allowing for an easy and efficient modification of the system in accordance with changes in the parking rules and regulations.

FIG. 3 shows the master remote device 900 that is used for reprogramming the timing meter device 20 by the parking authority 90 (FIG. 1) by transmitting an IR signal with a unique identification code of the parking authority 90. The IR signal that is sent by an infrared transmitter 920 of the master remote device 900 incorporates a stream of data in the infrared signal, which in turn is received by an infrared receiver 27 and stored in the computer memory 22 of the timing meter device 20 as digital data. This newly received data modifies the operation of the computer program executed by the microprocessor 24 or changes the input data to the computer program, thereby changing various parameters, maximum values, costs or other data related to the operation of the timing meter device 20.

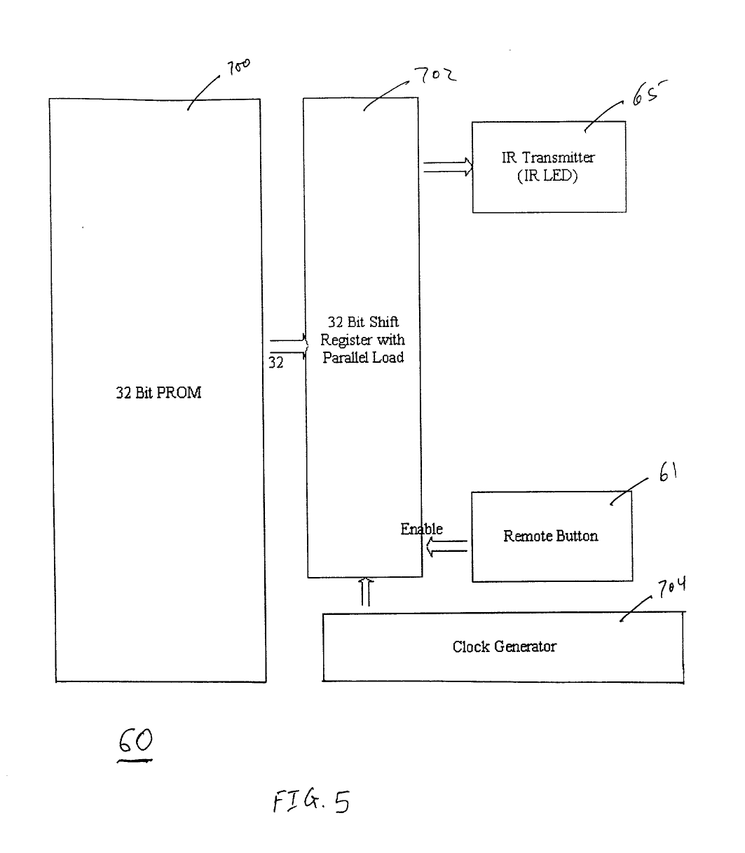

FIG. 5 illustrates schematically the remote device 60 that is used by the user 40 (FIG. 1). The remote device 60 is the same size as a conventional remote device and uses a conventional power source such as a dry cell battery. The remote device 60 has a memory 700, for example, programmable read only memory, that stores a user's unique identification code. The memory 700 may be, for example, 32-bit or 48-bit in size, the larger size providing greater number of possible combination for a user's identification code. The output of the memory 700 is connected to a shift register 702, which is the same size as the memory 700. A clock 704, for example, a 555 analog or digital timer IC, is coupled to the shift register 702. The output of the shift register 702 is coupled with the IR transmitter 65. When the button 61 is pressed the data from memory 700 is loaded in shift register 702 in one clock cycle. Next the data is shifted out, a bit at a time, thereby generating the IR signal 70 (FIG. 1). When all data is transmitted the remote device 60 will stop till the button 61 is pressed again.

The shift register 702 of the remote device 60 may be replaced with multiple shift register of smaller size, for example, the 32-bit shift register may be replaced by four 8-bit shift registers.

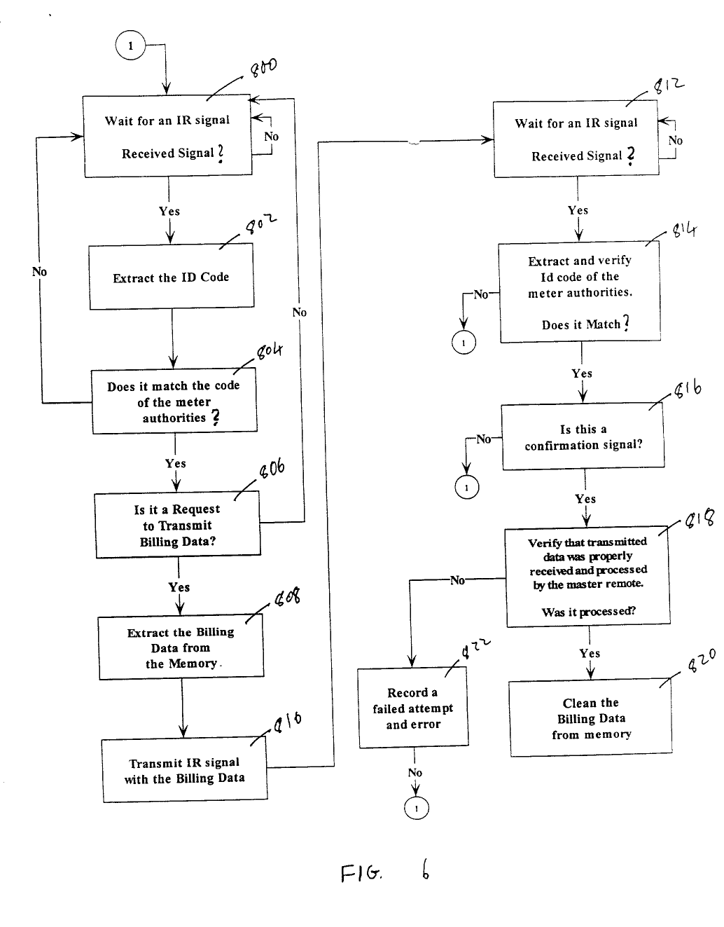

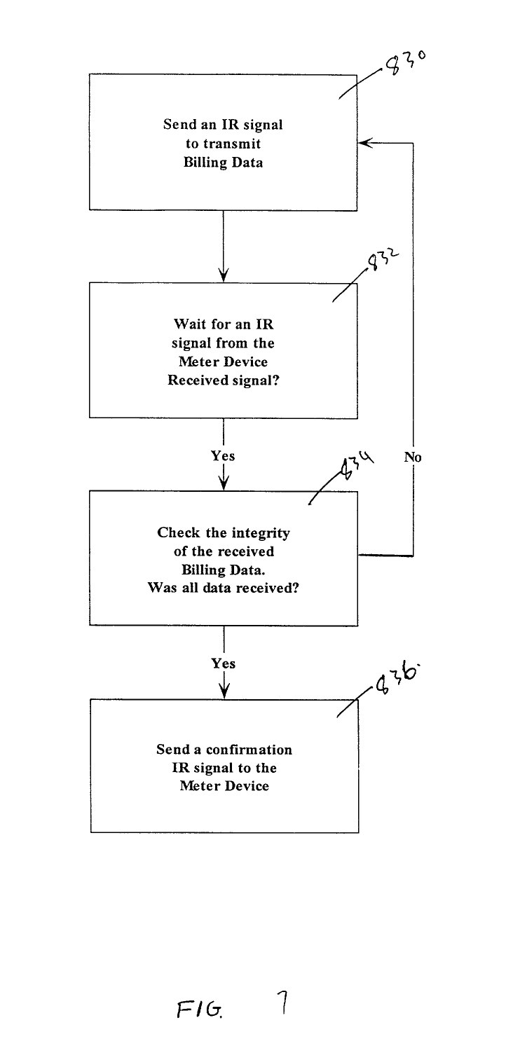

Referring to FIGS. 3, 6 and 7, the master remote device 900 that is used by the parking authority 90 may extract the billing information from the timing meter device 20 by sending an IR signal requesting stored billing information and including the identification code of the parking authority 90. Referring to FIG. 6, in step 800, the signal requesting the billing information is received by the IR receiver 27 of the timing meter device 20 and the identification code is extracted (step 802) and verified to be that of the parking authority 90 (step 804). In step 806 it is determined whether the signal is requesting the billing data. If the signal is requesting billing data, then in step 808 the billing data is extracted from the computer memory 22 and transmitted (step 810) as an IR signal to the master remote device 900 by the IR transmitter 21 of the timing meter device 20. If the request is not for billing data then the timing meter device returns to step 800. The receiver 910 of the master remote device 900 receives the IR signal, verifies the integrity of the billing data and stores the data in the memory means 950 of the master remote device 900 for future processing and individual billing of each user 40 of the timing meter device 20. The memory means 950 are preferably a random access computer memory or any other type of a device able to store digital data.

The master remote device 900, after confirming that the received data was properly received and processed sends a signal to the timing meter device 20 (step 812). The timing meter device 20 verifies that IR signal received has the code of the meter authorities 90 (step 814) and upon confirming that the code belongs to the meter authorities (step 816) and the transmitted data was properly received and processed by the master remote 900 (step 818), erases the information stored in the computer memory 22 (step 820) of the timing meter device 20. If there is an error in receiving of the data by master remote 900 then a failed attempt to transfer data is recorded (step 822) and the information stored in computer memory 22 is not erased.

FIG. 8 is a flow diagram illustrating steps performed by the master remote device 900 for extracting data from timing meter device 20. The master remote device 900 transmits a infrared signal to the timing meter device 20 requesting the billing data (step 830). The master remote device 900 then waits for receipt of an infrared signal from the timing meter device 20 (step 832). Upon receipt of the infrared signal from the timing meter device 20, the master remote device 900, in step 834, checks the integrity of the data carried by the infrared signal from timing meter device 20. If there is an error in receipt of the data, the master remote device 900 returns to step 830. If all of the data received is properly received and processed by the timing meter device 900, it sends a confirmation signal to the timing meter device 20 (step 836) confirming the satisfactory receipt of the data.

In addition, the timing meter device 20 preferably has the display device 260 (FIG. 2A) that is of an LED, LCD or another type able to light up a particular color or display an indicator in response to the reception of the IR signal 70 (FIG. 1) from the remote device 60. The display 260 of the timing meter device 20 preferably lights up a green color display when the user 40 activates it and the unique user identification is received and processed by the timing meter device 20. The green light on the display 260 preferably also indicates that the vehicle 50 (FIG. 1) of the user 40 is properly parked in the parking location monitored by the timing meter device 20. In contrast, the display 260 of the timing meter device 20 preferably lights up a red color display when either the maximum time limit allowed for the vehicle 50 has run out or the vehicle 50 is illegally parked at the parking location monitored by the timing meter device 20. The yellow light indicates that the user can increment or decrement a preselectable increment of time up to the maximum time limit allowed.

In another embodiment, the timing meter system 10 of the current invention may include a conventional motion or proximity detector 29 (FIG. 1). The motion or proximity detector 29, detects the vehicle 50 that arrives at the particular parking location next to the timing meter device 20 and produces a signal to the display 260 to light up the preferably red light, indicating that the vehicle is illegally parked. Then, the operator of the vehicle 50 (i.e., the user 40) activates the timing meter device 20 with his or her infrared remote device 60 by sending the IR signal 70 through the IR transmitter 65. Upon receipt of the IR signal 70, the unique identification code of the user 40 is extracted, verified and stored in the computer memory 22. Then, the timing meter device 20 directs the display 260 to change the light to the preferably green color, indicating that the timing meter device 20 had been properly activated and the vehicle 50 is legally parked. Thereafter, when a maximum amount of time that the vehicle 50 is allowed to be parked at that location is reached, the display 260 is directed to light up the preferably red light, indicating that the vehicle 50 is no longer legally parked at that location. Alternatively, if the motion or proximity detector 29 detects that the vehicle 50 has departed, the display 260 may preferably be turned off or be directed to change to the red color. Likewise, if the timed vehicle leaves and a different vehicle enters the protected parking spot, any time remaining on the timer will be canceled and the display 260 will indicate red until the new user parked at the location reactivates the meter device 20.

The invention is described with reference to a parking meter system, however, it may be used in many metering applications. For example, the timing meter system of the present invention may be utilized for telephones, fuel pumps, copying machines, soda machines, and other similar systems, where the user of a telephone, fuel pump or other similar devices would be able to activate them with an IR remote device. The timing meter device incorporated in these machines would store user data and activate a counter that records the time of a phone call, the amount of fuel purchased, number of copies or amount of soda purchased by the user, who is then billed for it at a later time.

Although the invention has been described with reference to the preferred embodiments, it will be apparent to one skilled in the art that variations and modifications are contemplated within the spirit and scope of the invention. The drawings and description of the preferred embodiment are made by way of example rather that to limit the scope of the invention, and it is intended to cover within the spirit and scope of the invention all such changes and modifications.

APPENDIX A
#define MAX_USERS 25

| int | user1; | |
|---|---|---|
| long | temp_time; | |
| long | end_time; | |
| int | time_expired = 0; /*flag if user's time r | |
| int | users = 0; /*Number of people logged sinc | |
| int | userlog | [MAX_USERS]; |
| int | usertime | [MAX_USERS]; |

| | | |
|---|---|---|
| float | usercost | [MAX_USERS]; |
| char | userout | [MAX_USERS]; |

| | | |
|---|---|---|
| float | cost_per_minute = 0.035; | /*one cent a minute*/ |
| float | min_charge = 0.25; | /* 10 cent minimum charge */ |

| | | |
|---|---|---|
| float | max_charge = 2.0; | /* $2.00 maximum charge */ |
| int | meter_max_time = 240; | /* 2 Hour Max park */ |
| int | percent_cut = 4; | /* Amount of time (1/N)*max_meter_time to deduct |
| from | | |

user_max_time with each button press*/

| | | |
|---|---|---|
| int | percent_add = 4; | /*amount to add... */ |

| | |
|---|---|
| int user_max_time = 240; | /* Does not need to be initialized, but |
| is... */ | |
| int currently_parked = 0; | /* 1 if someone is parked, 0 if space is |
| empty, other if meter busy */ | |
| void main( ) | |
| { | |

| int result, i = 0; | |
|---|---|
| int error_code, valid = 0; | |
| int valid2 = 0; | |
| start_process (parked( )); | |
| currently_parked = 3; | |
| poke (0x1009, 0x3c); | /*enable digital outputs*/ |
| poke(0x1008, 00000010); | /*Turn on Yellow -Hold- LED*/ |

| | |
|---|---|
| printf (“\nIRPS BOOTING | Please Wait.\n”); |
| for (i = 0; i < 60; i++) | |
| { | |

printf (“IRPS BOOTING.\n”);
printf (“IRPS BOOTING..\n”);
printf (“IRPS BOOTING...\n”);

} /*Wait For A Few Seconds*/
start_process(parked( ), 5);
poke(0x1008, 00100000); /*Light Red LED*/

while (1)
{

| sony_init (1); | |
|---|---|
| printf (“\n IRPS Ready | Press Remote\n”); |
| currently_parked = 0; | |
| while (!valid) | |
| { | |

result = wait_for_park( );
valid = check_valid (result);

}
set_max_time( );
start_park( );
currently_parked = 1;
user1 = result;
while (!valid2 & !time_expired)
{

result = wait_for_end( );
valid2 = check_valid (result);

}
if (time_expired)

{
end_park(2); /*Time Expired*/
valid = 0;
valid2 = 0;
result = 0;
}

else if (result == user1)

{
if (ask_more_time( ))

{
end_park(0); /*Same User, Wants to log out*/
result = 0;
valid = 0;
valid2 = 0;
}

}

else

{
end_park(1); /*Last user forgot to stop meter when leaving.*/
/* valid still = 1*/
valid2 = 0;
}

}
return;

}
/*******************************************
int wait_for_park ( )
this function waits for an infra red signal
to be detected. If it is detected the number is
returned. (if the ir signal is not formatted
properly it will not even detect it.)
******************************************/
int wait_for_park ( )
{

int result = 0;
while (!result)
{

result = ir_data(0);

}
return (result);

}
/*******************************************
int wait_for_end ( )
this function waits for an infra red signal
to be detected. If it is detected the number is
returned. (if the ir signal is not formatted
properly it will not even detect it.)
*******************************************/
int wait_for_end ( )
{

int result = 0;
while (!result)
{

result = ir_data(0);

}
return (result);

}
/*******************************************
int check_valid(int)
this function tests to signal recieved to
ensure it is a valid code.
if it is valid it returns a 1, otherwise a 0;
valid if it is an even number between 100 and 200.
*******************************************/
int check_valid (int result)
{

if ( result < 100 | | result > 200)

return 0;

if ((result % 2) == 1)

return 0;

return 1;

}
/*******************************************
set_max_time( )
This function is used to get the maximum time the user
would like to park for... it allows the user to press
the remote button multiple times within with first few seconds
to decrease max amount of time
*******************************************/
void set_max_time( )
{

int cut_max = 0;
long time_idle_msecs = 0L;
int do_it_once = 1; /*Used to make a while loop into Do-While loop*/
poke(0x1008, 00000010); /*Turn on Yellow -Hold- LED*/
user_max_time = meter_max_time;
while (cut_max | | do_it_once)
{

| reset_system_time( ); | |
|---|---|
| time_idle_msecs = mseconds( ); | |
| user_max_time -= ( (meter_max_time * (1 - do_it_once) ) / percent_cut); | |
| if (user_max_time < 1) | /*Reset to Max time*/ |

user_max_time = meter_max_time;

| | |
|---|---|
| printf (“\nMax Time | %d Min\n” , user_max_time); |
| do_it_once = 0; | |
| cut_max = 0; | |

while (!cut_max & time_idle_msecs < 3000L)
{

cut_max = ir_data(0);
time_idle_msecs = mseconds( );

}

}
/*User's maximum time is now set*/
return;

}
/*******************************************
start_park( )
this function is called each time a new user parks.
It resets the system clock.
*******************************************/
void start_park ( )
{

poke(0x1008, 00010000); /*Light green LED, turn off others*/
reset_system_time( );
time_expired = 0;
currently_parked = 1;
temp_time = 0L;
return;

}
/*******************************************
int end_park (int end_type)
this function is responsible for storing the length of time,
cost, and user id to a log. The function also checks to see
if the maximum or minimum charge was reached, and if the user
forgot to log out (press remote button a second time) before
leaving.
If the user is logging out (and therefore is presumably there)
the meter displays the total time for parking and says goodbye
before reseting to idle mode.
*******************************************/
int end_park (int end_type)
{

long timep;
int minp;
float cost;
poke(0x1008, 00100000);
currently_parked = 2;
timep = mseconds( );
for (minp = 0; timep > 0L; minp++)

timep -= 60000L;

/* minp = (int) (mseconds( ) / 60000L); CANT BE DONE! */

users++;
if (users > MAX_USERS)

return (1); /* ERROR -Memory Full! */

userlog[users] = user1;
usertime[users] = minp;
cost = cost_per_minute * (float) minp; /*calculate charge*/
if (cost < min_charge)

usercost[users] = min_charge;

else if (cost > max_charge)

usercost[users] = max_charge;

else

usercost[users] = cost;

poke(0x1008, 00100000); /*Light Red LED, turn of green LED*/
if (end_type) /*User forgot to log out OR time expired*/

{
poke(0x1008, 00000010); /*Turn on Yellow -Hold- LED*/
userout[users] = 1; /*Keep record that user didn't log out*/
printf (“\nPlease Hold\n”);
sleep (1.0);
}

else if (end_type == 0)

{
userout[users] = 0;
printf (“\nTotal Time %d Minutes\n” , usertime[users]);
sleep(2.5); /*Display goodbye information*/
printf (“\nTotal Cost $%f \n” , usercost[users]);
sleep(2.5); /*Display goodbye information*/
}

else /*end_type = 2 -> time expired*/

{

printf (“\nTIME EXPIRED\n”);
sleep (2.0);

}

return (0); /*No Error*/

}
/*******************************************
ask_more_time( )
This function is called when the same user who has been parked presses the
button on the remote IR unit. This will determine whether the user
wants to log out or add more time to the meter.
*******************************************/
int ask_more_time( )
{

int max_add_time = meter_max_time - user_max_time;
int user_max_add_time = 0;
int do_it_once = 1; /*Used to make a while loop into Do-While loop*/
long time_idleA = 0L;
long time_idleB = 0L;
long time_idle_msecs = 0L;
int add_time = 0;
int minp = 0;
long timep = 0L;
timep = mseconds( );
for (minp = 0; timep > 0L; minp++)

timep -= 60000L;

if (max_add_time <= 0)

return 1; /*Not allowed to add more time*/

printf (“\n%d Minutes Remaining\n” , minp);
sleep(1.5);
printf (“\nCan Add Up to %d minutes\n” , max_add_time);
sleep(1.5);
printf (“\nPress Remote To Add Time\n”);
while (add_time | | do_it_once)
{

do_it_once = 0;
add_time = 0;
time_idleA = mseconds( );
while (!add_time & ( (mseconds( ) - time idleA) < 2500L))
{

add_time = ir_data(0);

}
if (add_time)
{

user_max_add_time += (max_add_time / percent_add);
if (user_max_add_time > max_add_time)

{
user_max_add_time = max_add_time / percent_add;
printf (“\nAdd %d Minutes\n”, user_max_add_time);
}

}

}
user_max_time += user_max_add_time; /*Time Added*/
printf (“\nTime Added\n”);
sleep(1.0);
if (user_max_add_time)

return 0; /*added time, dont log out*/

return 1; /*Doesn't want to add time, Log them out*/

}
/*******************************************
parked( )
This function will “always” be running as a seperate process
it checks to see if a user has been parked too long
and updates the display.
*******************************************/
void parked ( )
{

long timep = 0L;
int count_hold = 0;

while (1)

{
timep = mseconds( );
if (currently_parked == 1)
{

| | |
|---|---|
| if ( timep > ( (long)user_max_time * 60000L) ) | /* Max time has been |

reached */

{

time_expired = 1;
printf (“\nTIME EXPIRED\n”);
poke(0x1008, 00100000); /*Light RED LED*/

}
else

printf (“\nParked\n”);

}
for (count_hold = 0; count_hold < 250; count_hold++); /*delay*/
}
return;

}

What is claimed is:

1. A timing meter system comprising:
an electronic timing meter device having a storage means for storing an identification of a user and an amount of time said user can be charged, an infrared receiver and a re-settable timer counter responsive to infrared signals received by said infrared receiver;
a remote device capable of generating infrared signals, said infrared signals having said identification of said user and being capable of activating said re-settable timer counter and setting said amount of time that said user can be charged.

2. The timing meter system of claim 1, wherein a first infrared signal initiates recording of a time interval and a second infrared signal operates to stop recording said time interval.

3. The timing meter system of claim 2, wherein said storage means are utilized to store said time interval and information specific to said user of said remote device.

4. The timing meter system of claim 3, wherein said information specific to said user is billing information of said user.

5. The timing meter system of claim 3, wherein said storage means has stored in it information specific to said timing meter device.

6. The timing meter system of claim 5, wherein said information specific to said timing meter device includes cost of use of said timing meter device and a restriction on use of timing meter device.

7. The timing meter system of claim 3, wherein said timing meter device further comprises an infrared transmitter capable of transferring said information specific to said user and said stored time interval as a second infrared signal to an infrared receiver.

8. The timing meter system of claim 1, wherein said timing meter device includes at least one visual display, said visual display being turned on in response to said infrared signal from said remote device.

9. The timing meter system of claim 1, wherein said timing meter device further comprises a shielding to prevent electromagnetic interference from the external sources with said reception of said infrared signals.

10. The timing meter system of claim 1, wherein said timing meter device further comprises a power source means that provide electricity for said timing meter device.

11. The timing meter system of claim 10, wherein said power source means is at least one rechargeable battery.

12. The timing meter system of claim 11, wherein said rechargeable battery is recharged by solar radiation.

13. The timing meter system of claim 1, wherein said timing meter device further comprises a proximity detector for determining the absence or presence of a vehicle in the proximity of said timing meter device.

14. The timing meter system of claim 1, wherein the amount of time set in said resettable timer is a maximum amount of time said user can be charged.

15. The timing meter system of claim 1, wherein a first infrared signal sets a maximum time in said resettable timer and a second infrared signal decrements said time a preset amount.

16. A parking meter system comprising:
an electronic parking meter device having a programmable memory, an infrared receiver and a re-settable timer counter responsive to a first infrared signal received by said infrared receiver;
a remote device capable of generating said first infrared signal, said infrared signal having identification of a user and being capable of activating said re-settable timer counter and setting an amount of time that said user can be charged; means for storing said user identification and said charge in said memory.

17. The parking meter system of claim 16, further comprising:
a master remote device capable of generating a second infrared signal, means in said program memory responsive to said second infrared signal for reprogramming said programmable memory.

18. The parking meter system of claim 17, wherein said second infrared signal from said master remote device initiates transmission of data stored in said programmable memory to said master remote device.

19. The parking meter system of claim 18, wherein said second infrared signals contain identification of parking authorities.

20. The parking meter system of claim 16, wherein said first infrared signal initiates recording of a time interval and a second infrared signal from said remote device stops recording of said time interval.

21. The parking meter system of claim 16, wherein said programmable memory stores said time interval and information specific to said user of said remote device.

22. The parking meter system of claim 21, wherein said information specific to said user is billing information of said user.

23. The parking meter system of claim 21, wherein said programmable memory also stores an information specific to said parking meter device.

24. The parking meter system of claim 23, wherein said information specific to said parking meter device consists of a cost of use of said parking meter device and at least one restriction on said use of said parking meter device.

25. The parking meter system of claim 21, wherein said parking meter device further comprises an infrared transmitter capable of transferring said information specific to said user and said stored time interval as a third infrared signal to an infrared receiver.

26. The parking meter system as claimed in claim 17, wherein said parking meter device further includes a shielding to prevent electro-magnetic interference from the external sources with said reception of said first infrared signals, said second infrared signals.

27. The parking meter system of claim 17, wherein said parking meter device further comprises a power source means that provide electricity for said parking meter device.

28. The parking meter system of claim 27, wherein said power source means is at least one rechargeable battery mounted in said parking meter device.

29. The parking meter system of claim 28, wherein said rechargeable battery is recharged by solar radiation.

30. The parking meter system of claim 17, wherein said parking meter device further includes a proximity detector device for determining the absence or presence of a vehicle in the proximity of said parking meter device.

31. A parking meter system comprising:
a parking meter device having a display constructed and arranged to display a time and amount charged for parking for said time, indicator light means for indicating the status of a parked vehicle, and electronic circuitry for receiving and processing infrared signals containing identity of a user of the parking facilities;
a remote device for generating a first infrared signal, said first infrared signal having identification of said user imbedded therein and capable of setting a maximum amount of time for said parking meter device that said user can be charged.
a master remote device for generating a second infrared signal, said second infrared signal having identification of parking authorities imbedded therein and capable of reprogramming said electronic circuitry in said parking meter device.

32. The parking meter system of claim 31, wherein said electronic circuitry is responsive to an infrared signal from said master remote device and transmits an infrared signal to said master remote device containing said user's identification and billing information, and storing said user's identification and billing information in said master remote device.

33. The parking meter system of claim 32, further comprising:
a proximity sensing means, said proximity sensing means is coupled to said electronic circuitry and senses the absence or presence of a vehicle in a parking space associated with said parking meter device.

34. A method of paying for parking, said method comprising the acts of:
parking a vehicle in a parking space associated with a parking meter device;
activating said parking meter device via said infrared signal, operating an infrared signal having user identification and user billing information imbedded therein;
deactivating said parking meter device via said infrared signal;
storing time interval between activating and deactivating of said parking meter device in a storage device in said parking meter device;
storing said user identification and user billing information in said storage device;
setting the maximum time that can be charged to said user using said infrared signal;
collecting said time interval and said user's billing information from said storage means; and
charging said user's account based upon said information collected from said storage means.

35. The method of claim 34, further comprising:
sensing the absence of said vehicle; and
deactivating said parking meter device when said vehicle is absent.
